(19) United States
(12) Patent Application Publication
(10) Pub. No.: US 2012/0241319 A1
(43) Pub. Date: Sep. 27, 2012

(54) Gas Detector Having Bipolar Counter/Reference Electrode

(75) Inventors: Graeme Ramsay Mitchell, Poole (GB); Martin Williamson, Poole (GB); John Chapples, Portsmouth (GB); Frans Monsees, Poole (GB)

(73) Assignee: Life Safety Distribution AG, Uster (CH)

(21) Appl. No.: 13/071,893

(22) Filed: Mar. 25, 2011

(51) Int. Cl. G01N 27/407; G01N 27/416; G01N 27/403

(52) U.S. Cl. 204/406; 204/431; 204/412

(57) ABSTRACT

A gas detector includes at least two electrodes. The electrodes are carried on a common substrate having first and second spaced apart surfaces. The electrodes are formed on respective ones of the surfaces with the substrate sandwiched therebetween.

### FIELD

The application pertains to electro-chemical gas detectors. More particularly, the application pertains to such detectors which include electrode structures for improved detector performance.

### BACKGROUND

Electro-chemical gas sensors of various configurations are known. For example two electrode or three electrode structures can be combined with an appropriate electrolyte in a housing to provide compact, light weight gas sensor which can be combined with electronics and provided in an external housing in the form, for example, of a wearable gas detector.

While such detectors have been found to be extremely useful, at times, sensor output recovery, following exposure to a predetermined gas can take longer than desired. Preferably recovery times could be shortened with alternate configurations of various sensor elements.

FIGS. 1, 2 illustrate characteristics of prior art gas sensors 20, 30. As illustrated therein, electrochemical cells include a body (1) that acts as mounting point for three connection pins (2) that allow electrical connection to the current collectors (3) and in turn electrical connection to the working electrode (4), Counter Electrode (5) and Reference Electrode (6).The Electrodes and current collectors are electrically isolated by insulation material between the electrodes (7). These insulators also act as a means of transporting/dispersing electrolyte (8) around the internal components of the cell. The Electrodes and insulators form the top stack assembly (9) which is supported by a bottom stack compressor (10). The stack cap (11) is fitted to the top of the body with a hole located in the front face. Depending on the gas being measured various filter materials (12) in the form of powders etc are placed in the gas path between the cap and working electrode.

FIG. 1 illustrates a prior art sensor 20 with a “Split counter reference” electrode (5), 6) facing the working electrode (4). This design benefits from a very short distance between the working, reference and counter electrodes minimizing the ionic impedance. The lower the impedance is, the faster the cell responds to a change in gas concentration, which is advantageous. The disadvantage of this design is that with prolonged and or repeated gas application the reference electrode is exposed to products of the electrochemical reactions undertaken at the counter and working electrodes resulting in a change in reference potential. The effects of this shift are manifest as what is known by those skilled in the art as a “positive baseline offset” (zero offset). When the gas is removed it can take several minutes or even hours for the offset to return to zero as the reference electrode returns to its pre-gassed condition. The higher the gas concentration and or longer the duration or number of repeated gas applications, the longer the time it takes for the baseline to return to zero.

FIG. 2 illustrates a prior art three electrode sensor 30 where a small diameter reference electrode (6) faces the working electrode (4) and a counter electrode (5) faces upwards/downwards. A plastic doughnut ring is used to shield the working electrode (4) from the counter electrode (5) and separators (7) are used between the working electrode (4) and the reference electrode (6) and also between the reference electrode (6) and counter electrode (5). The sensor 30 benefits from preventing the H+ ions from reaching the counter electrode (5) and hence the concentration gradient is over a much longer distance than the alternative sensor 20 in FIG. 1. This prevents the problem observed in the baseline behavior with the “Split Counter Reference” of FIG. 1. The disadvantage is that there are many insulators in the top stack which increases the ionic impedance and hence slows the cell's speed of response. Those knowledgeable in the art counter this by adding more electrolyte into the cell. However additional electrolyte may restrict the environmental window in which the cell can function without degradation in performance or potentially suffering from mechanical failure. This is due to the hygroscopic nature of the electrolyte which significantly increases in volume under conditions of high humidity. This failure mechanism is not always readily detected by the user and can potentially cause damage to the instrument in which the cell is housed.

### BRIEF DESCRIPTION OF THE DRAWINGS

FIG. 1 is an exploded view of a three electrode prior art sensor;

FIG. 2 is an exploded view of another three electrode prior art sensor;

FIG. 3 is an exploded view of a three electrode sensor in accordance herewith;

FIG. 4 illustrates additional details of bi-polar electrodes in accordance herewith;

FIGS. 5A, 5B, 5C illustrate performance characteristics of sensors as in FIG. 3; and

FIG. 6 illustrates a gas detector which incorporates a gas sensor as in FIG. 3.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Advantageously, in accordance with the present disclosure, the position/orientation of internal electrodes can be altered. Changing the position of the counter electrode in relation to the working/sensing electrode, with the counter facing away from the working electrode, as disclosed below, can produce improved sensor performance. However, merely moving the counter electrode away from the working/sensing electrode can result in a detrimental impact on other specified sensor performance characteristics, especially at temperature extremes (sensor baseline in air, sensitivity to target gas & response time—due to the increase in ionic impedance associated with moving the counter electrode).

There are also additional manufacturing issues associated with altering electrode positions. Known designs include counter & reference electrode catalyst deposited adjacent to each other on the same surface of a common substrate material.

Moving the counter electrode requires the counter and reference electrodes to be separated, requiring additional electrode substrate material (PTFE) and additional electrode separator material (Glass Fiber)—increasing direct cost of product, and increasing manufacturing complexity, with potential introduction of failure modes due to incorrect component placement poorly aligned separators/electrodes leading to shorting between electrodes. Changing the orientation of the counter electrode (to face away from working electrode) also introduces new manufacturing issues as there is no visibility of the catalyst pad during cutting and placement of the electrode.

Unlike merely moving the location of electrodes relative to one another, by creating a bipolar electrode as described below, the baseline recovery performance characteristic of the sensor can be improved.

The electrode is designed so that the counter and reference electrode catalyst pads are deposited on either side of the same insulating substrate, for example, a PTFE planar member. This design (compared to the alternative of using two separate counter and reference electrodes) benefits from not requiring an additional separator between the counter and reference electrodes. This reduces ionic impedance; improving baseline recovery performance and sensor response time (especially at low temperatures). Removing the requirement for an additional separator and having a common substrate for the electrodes reduces piece parts I direct product cost—also improving manufacturability with fewer opportunities for failure.

As counter and reference electrodes preferably face in opposite directions, using a shared substrate with back to back catalyst is beneficial for manufacturing as visibility of one catalyst pad ensures correct cutting and placement of components, and removes failure modes associated with electrode shorting. Additionally, as the electrodes are on a shared substrate, there will be faster temperature stabilization between the electrodes. Another manufacturing benefit is that by having a common carrier for the counter and reference electrodes, the orientation of the bipolar electrode has no effect on performance and facilitates manufacturing poke-yoke design.

A PTFE (substrate) sheet, or other type of insulating, or plastic sheet, can be clamped between two magnetic steel stencils, with electrode stencils aligned on each side, and stencils are loaded onto transfer plate using location reference pins for alignment and held flat using magnets. Catalyst material is then dispensed using an automated robotic dispensing system and cured. One such method is disclosed in U.S. Pat. No. 7,794,779 entitled “Method of Manufacturing Gas Diffusion Electrodes, which issued Sep. 14, 2010, and which is commonly owned. The '779 patent is hereby incorporated herein by reference.

The stencils are then removed from the transfer plate (whilst still clamping the substrate material), the stencils are turned over so the substrate surface with no catalyst is topmost. The stencils are loaded back onto the transfer plate (location pins ensure electrodes are aligned on both sides of sheet), the electrode catalyst for the second electrode is then dispensed and cured.

Stencils enable up to 144 electrodes, or more, to be dispensed per substrate sheet. The electrodes are then built into product on an automated assembly machine. Electrode sheets (144 electrodes per sheet) are loaded onto the assembly machine, and a vision system detects the location of individual electrodes to ensure correct cutting position (alignment of electrodes achieved at manufacture ensures that the electrode on opposite side of substrate is also cut correctly).

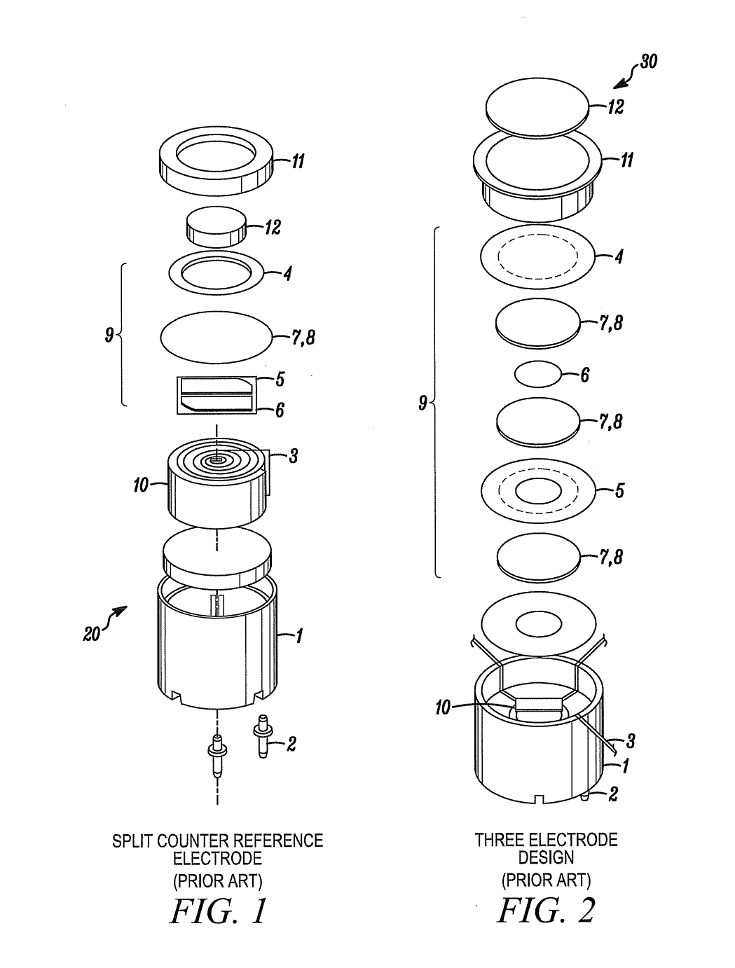

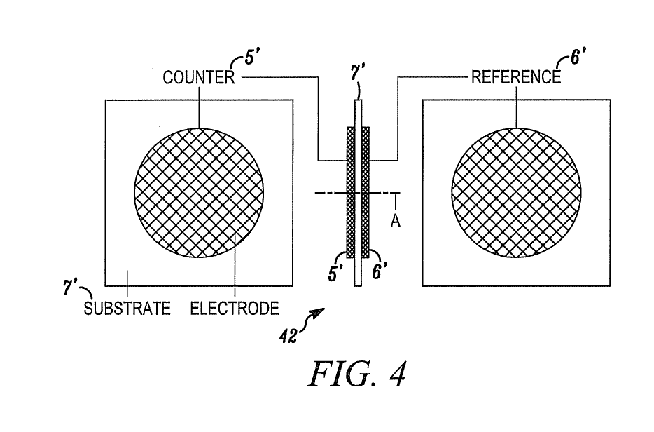

FIG. 3 illustrates a sensor 40 in accordance herewith that overcomes the deficiencies of the current art shown in FIGS. 1 & 2. The “Bipolar electrode” (42) of FIG. 3 has the reference electrode (6′) and the counter electrode (5′) located on a common insulating substrate (7′). The electrodes are positioned “back to back” on the substrate (7′). Forming the reference and counter electrodes (6′), (5′) on the same substrate (7′) ensures that the catalyst pads are in very close thermal proximity and hence any changes in the counter electrode activity/potential due to temperature are more quickly compensated for in the reference electrode (6′).

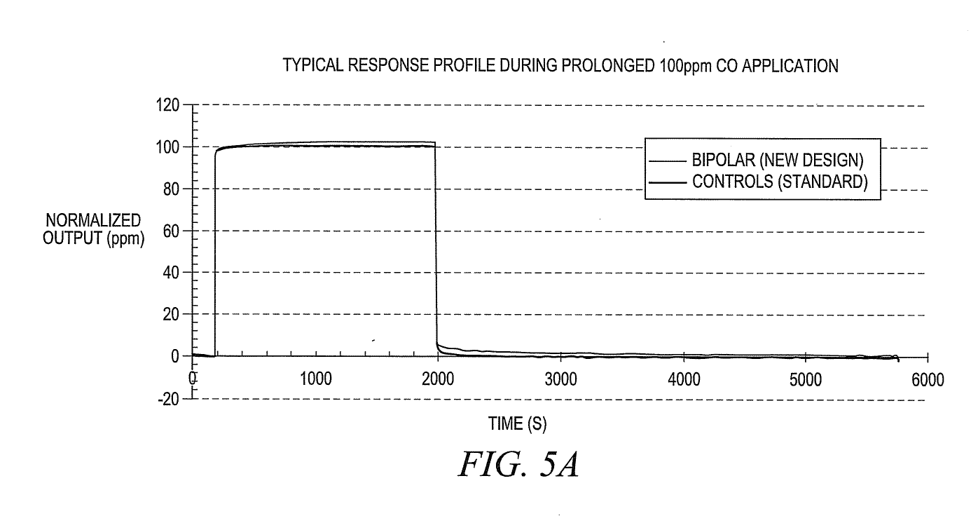

In the sensor 40, a common axial line A (best seen in FIG. 4) extends through each of the counter electrode (5), the reference electrode (6) and the insulating substrate (7′). Where the electrodes are substantially identical in shape, the line A comprises a common center line. It will be understood that the electrodes (5′), (6′) could have differing shapes without departing from the spirit and scope hereof.

Further the catalyst pad activities in the reference and counter are “tuned” to give the cell particular performance characteristics. As a result of sequentially applying the catalyst pads, the pads can be precisely matched/aligned. Hence, less variation is observed between cells of this design as opposed to those where the reference and counter are on separate substrates. One benefit, over the “split counter reference electrode” of sensor 20 of FIG. 1, is that there is a larger substrate to mount the reference and counter electrode pads. This allows the cell performance to be more easily customized/tuned for cost/performance and hence beneficial to manufacturers of the art.

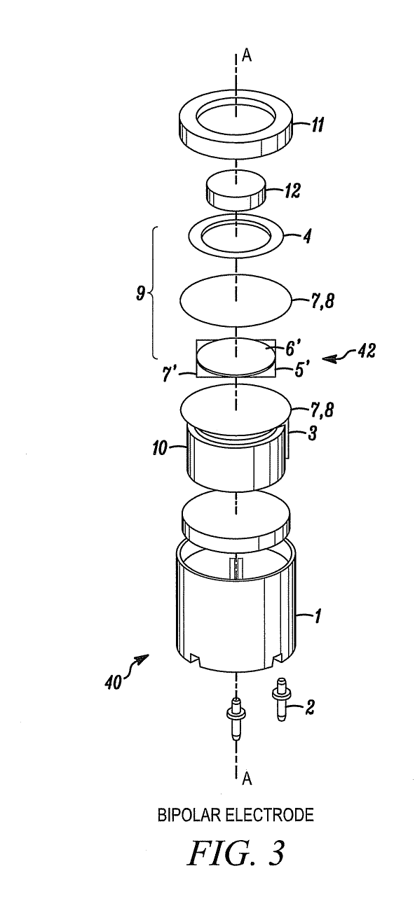

Another benefit, over the prior art of FIG. 2, is that there is one less separator; and hence, no requirement for a plastic doughnut shaped shield between the working and counter electrode. This significantly reduces the ionic impedance and hence the speed of response is comparable with the design of the prior art shown in FIG. 1, at ambient temperatures.

The sensor 40, in the disclosed embodiment, has a reference catalyst pad that is matched in diameter and loading to the counter, ensuring the component is poke/yoke (i.e., reference and counter catalyst pads are identical; hence orientation is not of importance during assembly). The bipolar electrode (42) also brings significant commercial advantage over the prior art, shown in FIG. 2 as one less plastic substrate is required to support the electrode catalyst, no plastic doughnut seal/guard is required and some separators are eliminated compared to the sensor 30 shown in FIG. 2.

The bipolar electrode (42) also brings significant reduction in the number of parts. A simpler design means there is a reduction in the potential number of defects from misplaced insulators and hence short circuits/bad connections in the electro-chemical cell.

FIG. 4 illustrates details of the design of the bipolar electrode (42) usable in a carbon monoxide electro-chemical cell. The electrode substrate could be larger or smaller or a different shape to that shown in FIG. 4, without limitation. Similarly the catalyst pads which are shown round, could be square or in fact any shape. The loading per unit area of the catalyst pad can be larger or smaller than as in the example of FIG. 4. Similarly, the counter and reference electrodes (5′), (6′) could equally be larger or smaller than as illustrated in FIG. 2 and while preferably having the same diameter and loading, they could be tuned to meet different performance characteristics. The axial line A, which might be a common center line, extends therethrough.

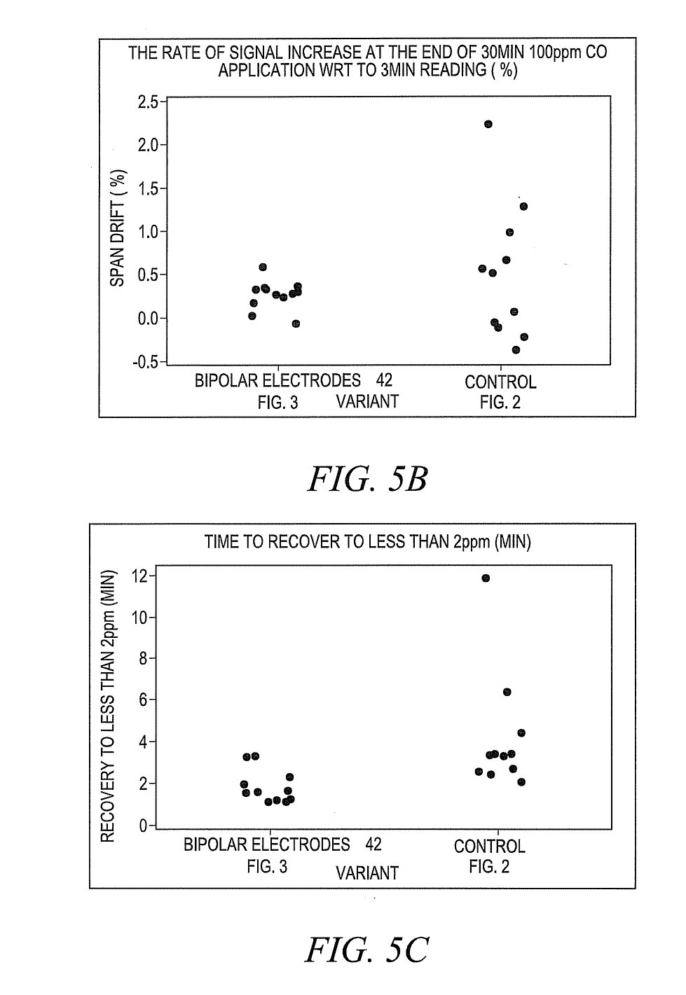

FIGS. 5A, 5B, 5C illustrate performance aspects of the sensor 40 of FIG. 3 compared to sensor 30 of FIG. 2. Bipolar electrodes, such as electrodes (42), exhibit tighter span drift characteristics and tighter, shorter, recovery times to carbon monoxide when compared to control sensors 30 of FIG. 2.

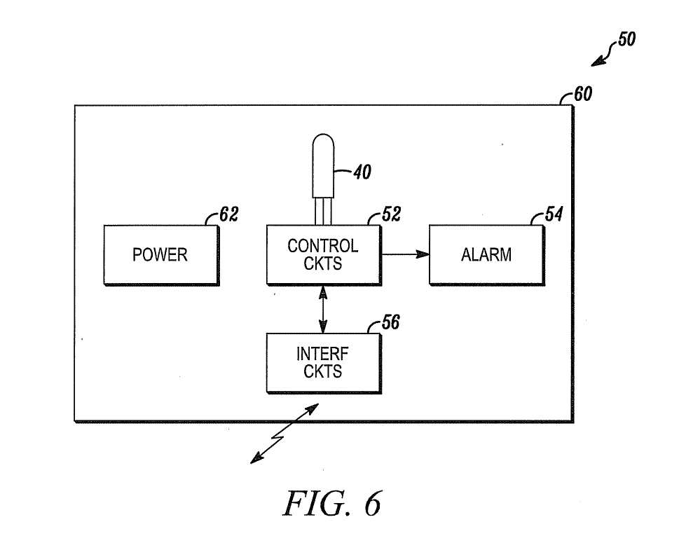

FIG. 6 illustrates a gas detector 50 which includes the gas sensor 40. The detector 50 includes control circuits 52 coupled to the gas sensor 40. The control circuits 52 are coupled to an alarm output 54, audible or visual, as well as interface circuits 56. Circuits 56 can place the detector 50 into bidirectional wired or wireless communication with an external regional monitoring system or a docking station. The above components can be carried in a housing 60, which, could be carried by a user, and power by a supply 62, for example a battery.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. A gas detector comprising:
a gas sensor having a common substrate and first and second electrodes formed thereon with the substrate therebetween; and
a housing which carries the sensor.

2. A detector as in claim 1 wherein the substrate has first and second planar surfaces with the electrodes formed on respective ones of the surfaces.

3. A detector as in claim 1 where the electrodes are selected from a class which includes at least a cylindrical profile, a square profile, or a rectangular profile.

4. A detector as in claim 1 where the electrodes are arranged along a common center line.

5. A detector as in claim 1 where the electrodes are symmetrical with respect to a common axially extending line.

6. A detector as in claim 5 where the axially extending line comprises a common center line that also passes through the common substrate and is substantially perpendicular thereto.

7. A detector as in claim 6 where the housing extends generally parallel to the common center line.

8. A detector as in claim 5 which includes control circuits coupled to the sensor and wherein the control circuits, responsive to signals from the sensor, determine the presence of a selected gas.

9. A detector as in claim 8 which includes a cylindrical insulator positioned adjacent to each of the electrodes and the common substrate.

10. A gas sensor comprising:
an elongated hollow housing;
a stack compressor carried in the housing;
a first insulating layer overlying an end of the stack compressor;
a composite electrode structure overlaying the first insulating layer where the electrode structure has a first electrode, another insulator and a second electrode with the insulator located between the two electrodes; and
a third insulating layer which overlays the composite electrode structure.

11. A sensor as in claim 10 where the first and second electrodes are formed on the insulator with substantially identical shapes.

12. A sensor as in claim 10 where the insulator comprises a planar insulating sheet member.

13. A sensor as in claim 10 which includes a selected electrolyte located at least on each side of the composite electrode structure.

14. A sensor as in claim 13 which includes a plurality of contacts, which extend from the housing adjacent to the stack compressor, the contacts are coupled to the electrodes.

15. A sensor as in claim 10 where the insulator comprises a planar PTFE sheet member.

16. A gas sensor comprising at least two electrodes where the electrodes are carried on a common insulating substrate having first and second spaced apart surfaces where the electrodes are formed on respective ones of the surfaces with the substrate sandwiched therebetween.

17. A sensor as in claim 16 where the electrodes are substantially identical in shape.

18. A sensor as in claim 17 where a common center line extends through the electrodes and the substrate.

19. A sensor as in claim 17 which includes a third electrode spaced from the first and second electrodes.

20. A sensor as in claim 17 which include a hollow cylindrical housing which surrounds the electrodes, where a common center line extends through the electrodes and the substrate, and, where the center line extends parallel to a centerline of the housing.
